(19) United States
(12) Patent Application Publication
(10) Pub. No.: US 2025/0244984 A1
(43) Pub. Date: Jul. 31, 2025

(54) AUTOMATED DEPLOYMENT OF RESOURCES USING VALIDATED TEMPLATES

(71) Applicant: Dell Products L.P., Round Rock, TX (US)

(72) Inventors: Deborah C. Russell, Arvada, CO (US); Craig O'Leary, Cork (IE)

(21) Appl. No.: 18/422,772

(22) Filed: Jan. 25, 2024

(51) Int. Cl. G06F 8/60; G06F 9/54

(52) U.S. Cl. CPC G06F 8/60; G06F 9/542

(57) ABSTRACT

Methods, apparatus, and processor-readable storage media for deploying computing resources using validated templates are provided herein. An example computer-implemented method includes identifying an event associated with a set of templates, where each template comprises information for a corresponding resource configuration of a computing environment in information technology infrastructure, and performing a validation process in response to the identified event, where the validation process validates a given template in the set of templates based at least in part on a comparison of the resource configuration corresponding to the given template to one or more characteristics associated with a user. The method also includes enabling the given template to be selected by the user based on a result of the validation process, and automatically deploying one or more computing resources based on the resource configuration corresponding to the given template in response to a selection of the given template by the user.

### BACKGROUND

Information processing systems increasingly utilize reconfigurable resources to meet changing user needs in an efficient, flexible and cost-effective manner. For example, cloud-based computing and storage systems implemented using virtual resources in the form of containers have been widely adopted. Such containers may be used to provide at least a portion of the virtualization infrastructure of a given information processing system.

### SUMMARY

Illustrative embodiments of the disclosure provide techniques for automated deployment of resources using validated templates. An exemplary computer-implemented method includes identifying an event associated with a set of one or more templates, where each template in the set comprises information for a corresponding resource configuration of a computing environment in information technology infrastructure, and performing a validation process in response to the identified event, where the validation process validates a given template in the set of templates based at least in part on a comparison of the resource configuration corresponding to the given template to one or more characteristics associated with at least one user. The method also includes enabling the given template to be selected by the at least one user based on a result of the validation process, and automatically deploying one or more computing resources based on the resource configuration corresponding to the given template in response to a selection of the given template by the at least one user.

Illustrative embodiments can provide significant advantages relative to conventional deployment techniques. For example, technical problems associated with deploying computing resources are mitigated in one or more embodiments by providing a framework for automatically deploying computing resources based on a template validation process.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated deployment of resources using validated templates in an illustrative embodiment.

FIG. 2 shows an automated deployment architecture in an illustrative embodiment.

FIGS. 3A and 3B show examples of template files in illustrative embodiments.

FIG. 4 shows a flow diagram for validating template files in an illustrative embodiment.

FIG. 5 shows a flow diagram of a deployment process in an illustrative embodiment.

FIGS. 6A and 6B show views of a template selection interface in an illustrative embodiment.

FIG. 7 shows a view of a deployment interface in an illustrative embodiment.

FIG. 8 shows another view of a deployment interface in an illustrative embodiment.

FIG. 9 shows a flow diagram of a process for automated deployment of resources using validated templates in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

A deployment process (e.g., a bare metal deployment process) typically includes manually providing parameters related to a deployment workflow and/or uploading a configuration file that specifies a set of parameters at some point during a deployment workflow. For situations when a configuration file is uploaded, a user generally needs to manually determine and verify information (e.g., computing resources and/or parameters) related to the deployment and hardcode at least some of this information into the configuration file. The configuration file is uploaded to a deployment system, for example, where the configuration file is then mapped to a deployment workflow. Such deployment processes can be inefficient as they involve and rely on significant amounts of user input, which increases the likelihood that the deployment fails.

Some embodiments described herein provide automated orchestration and deployment techniques that can reduce the likelihood of deployment failures while also improving the user experience. For example, at least some embodiments can automatically populate one or more parameters in a configuration file. The configuration file can then be shared and/or reused without having to manually hardcode user-specific values.

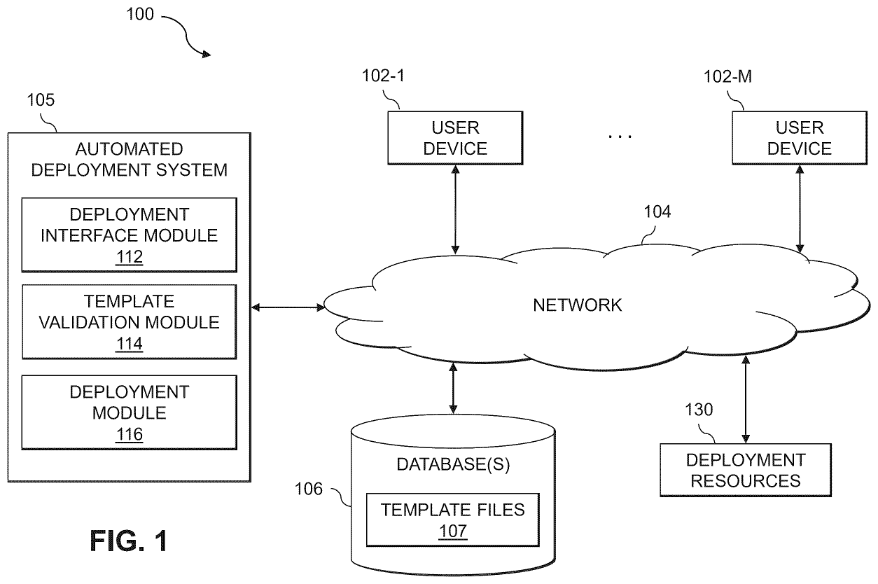

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an automated deployment system 105 and deployment resources 130.

The user devices 102 and/or deployment resources 130 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 and/or the deployment resources 130 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

It is to be understood that the deployment resources 130 may comprise one or more types of computing resources (e.g., hardware, software, and/or virtualized computing resources) associated with deployments. As a non-limiting example, portions of the deployment resources 130 may correspond to private cloud resources and/or public cloud resources provided by one or more cloud providers. Some embodiments are described herein with reference to bare metal deployments involving the deployment resources 130, however, these and other embodiments are also applicable to other deployment scenarios, such as infrastructure deployments, workload deployments (e.g., related to virtual machine (VM) and/or container deployments), application deployments, as well as other types of deployments involving other computing resources.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated deployment system 105 can have at least one associated database 106 configured to store template files (or data) 107 pertaining to, for example, different resource configurations.

An example database 106, such as depicted in the present embodiment, can be implemented using one or more storage systems associated with the automated deployment system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated deployment system 105 are one or more input-output devices, which illustratively comprise keyboards, displays or other types of input-output devices in any combination. Such input-output devices can be used, for example, to support one or more user interfaces to the automated deployment system 105, as well as to support communication between automated deployment system 105 and other related systems and devices not explicitly shown.

Additionally, the automated deployment system 105 in the FIG. 1 embodiment is assumed to be implemented using at least one processing device. Each such processing device generally comprises at least one processor and an associated memory, and implements one or more functional modules for controlling certain features of the automated deployment system 105.

More particularly, the automated deployment system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated deployment system 105 to communicate over the network 104 with the user devices 102, and illustratively comprises one or more conventional transceivers.

The automated deployment system 105 further comprises a deployment interface module 112, a template validation module 114, and a deployment module 116.

Generally, the deployment interface module 112 can include functionality for enabling one or more users (e.g., associated with one or more of the user devices 102) via a user interface (e.g., a graphical user interface (GUI) or a command line interface (CLI)). In some embodiments, the deployment interface module 112 may communicate information with the user devices 102 that can be used to implement the user interface, as described in more detail elsewhere herein.

The template validation module 114 can include functionality for automatically validating one or more of the template files 107. According to at least one embodiment, the template validation module 114 can be implemented as a service that subscribes to events associated with a change to one or more of the template files 107 and/or a new template file being added to the database 106, for example. The template validation module 114 can then perform a validation process for the template files corresponding to such events (e.g., to validate that the deployment resources 130 for the configuration related to a given template file are available).

The deployment module 116 generally includes functionality for configuring the deployment resources 130 according to a selected template file, as described in more detail elsewhere herein.

It is to be appreciated that this particular arrangement of elements 112, 114 and 116 illustrated in the automated deployment system 105 of the FIG. 1 embodiment is presented by way of example only, and alternative arrangements can be used in other embodiments. For example, the functionality associated with the elements 112, 114 and 116 in other embodiments can be combined into a single element, or separated across a larger number of elements. As another example, multiple distinct processors can be used to implement different ones of the elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automated deployment of resources using validated templates involving the automated deployment system 105, user devices 102 and/or deployment resources 130 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the automated deployment system 105, the deployment resources 130, and the database(s) 106 can be on and/or part of the same processing platform.

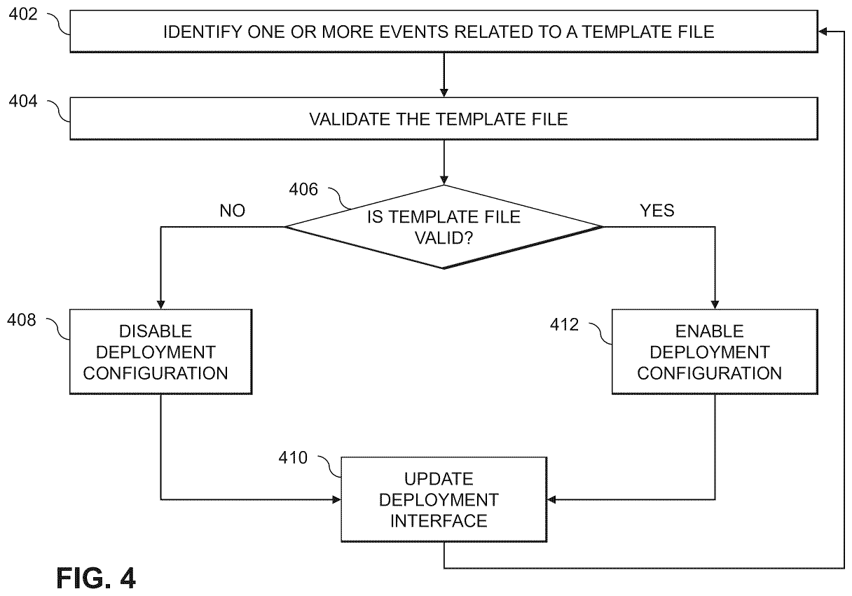

An exemplary process utilizing elements 112, 114 and 116 of an example automated deployment system 105 in computer network 100 will be described in more detail with reference to, for example, the flow diagrams of FIGS. 4, 5, and 9.

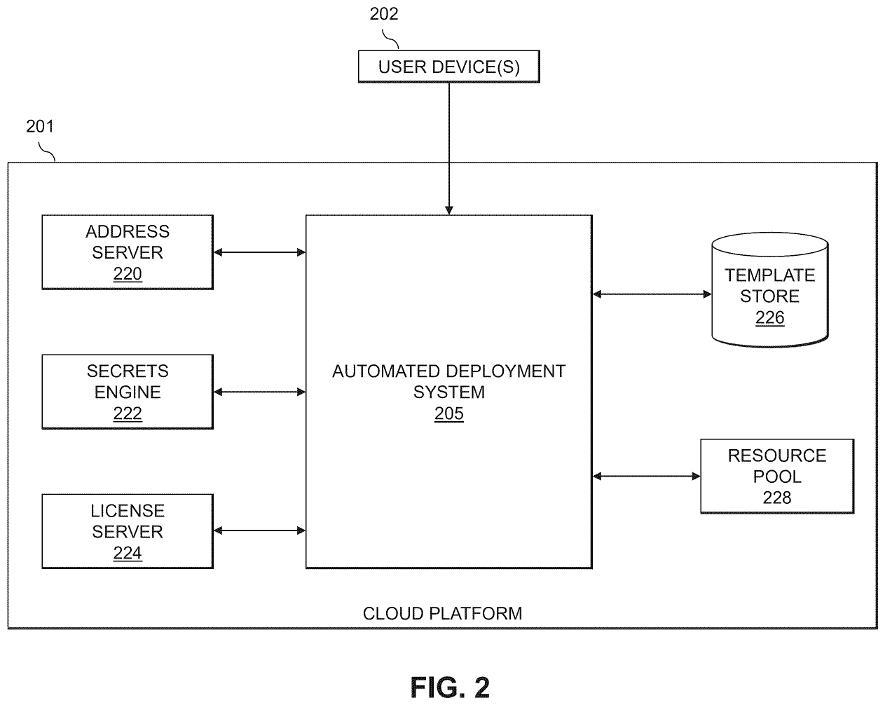

FIG. 2 shows an automated deployment architecture in an illustrative embodiment. In this example, the automated deployment architecture includes a user device 202 (e.g., corresponding to user device 102-1) and a cloud platform 201. The cloud platform 201 in the FIG. 2 example includes an automated deployment system 205 (e.g., corresponding to automated deployment system 105), an address server 220, a secrets engine 222, a license server 224, a template store 226, and a resource pool 228.

In some embodiments, a user device 202 can login to the automated deployment system 205, and the automated deployment system 205 can identify template files in the template store 226 that are associated with user device 202. In some embodiments, the template files can include one or more default resource configurations, one or more resource configurations previously configured by a user of the user device 202, and/or one or more resource configurations associated with an organization of the user, as non-limiting examples.

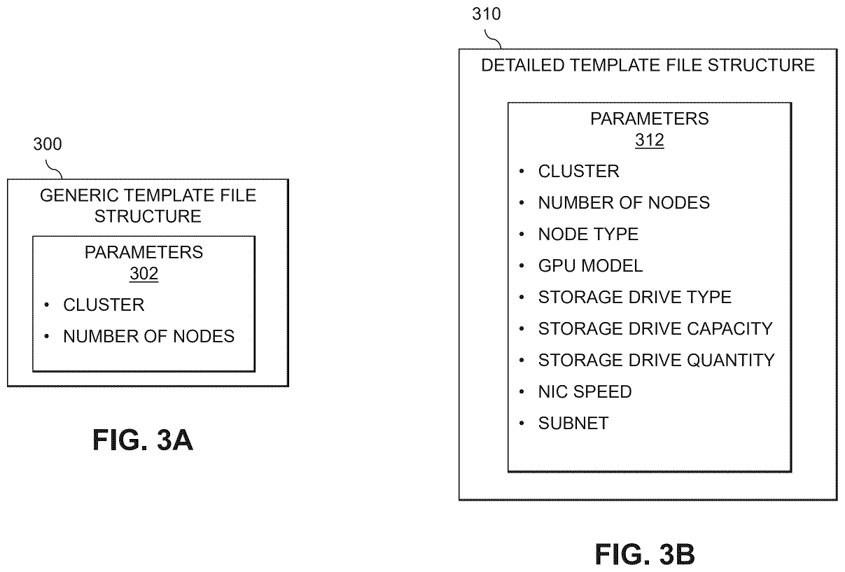

Generally, a given template file can be implemented as a text file (or any other suitable data structure) that includes information for a particular configuration of resources. For example, the text file can include values specified for a set of resource configuration parameters. FIGS. 3A and 3B show non-limiting examples of structures representing template files in illustrative embodiments. Specifically, FIG. 3A shows a generic template file structure 300 comprising a list of parameters 302, which includes a cluster type and a number of nodes. The cluster type can correspond to a particular deployment, service, or product type, and the number of nodes can correspond to the number of nodes to be used for the cluster for that type of deployment.

The detailed template file structure 310 shown in FIG. 3B includes a more detailed list of parameters 312, which includes additional information, relative to the generic template file structure 300 of FIG. 3A, related to a type of node, a graphics processing unit (GPU) model, storage drive type, storage drive capacity, storage drive quantity, a network interface card (NIC) speed, and subnet information. It is to be appreciated that different and/or additional parameters can be used in a given template file depending on the implementation, such as parameters related to one or more types of software (e.g., a type of hypervisor), as some types of hypervisors may be compatible with certain models of computing nodes. Alternatively, or additionally, a template file can include information related that refers to a particular performance level of a node (e.g., a bronze level, a silver level, or a gold level), where the different levels satisfy respective performance thresholds. For example, a template file can indicate that a resource configuration requires two “gold” nodes, which are then mapped to a particular set of characteristics (e.g., performance levels and/or quantities of storage, processing, and/or networking resources). In some embodiments, a template file can include information indicating an intended purpose. For example, if the template file indicates resources are needed for handling artificial intelligence models associated with a certain complexity and/or size, then the template file could be mapped to a particular configuration (e.g., a cluster having a particular number of nodes, a particular number and/or type of GPUs, a particular number and/or type of hard drives, and/or a particular type of NICs (e.g., fiber NICs).

According to some embodiments, the automated deployment system 205 can subscribe to events related to changes in the template store 226, such as events when a template file is added to the template store 226 and/or when one or more changes are made to a template file in the template store 226. When one of the events occurs, the automated deployment system 205 triggers a validation process, as described in more detail below in conjunction with FIG. 4.

FIG. 4 shows a flow diagram for validating template files in an illustrative embodiment. In this embodiment, the process includes steps 402 through 412. These steps are assumed to be performed by the automated deployment system 205, for example.

Step 402 includes identifying one or more events related to a template file. Step 404 includes validating the template file to validate that the template file can be used to deploy a corresponding resource configuration. In some embodiments, the validation performed in step 404 can be based on a set of parameters included in the template file and characteristics related to one or more users associated with the template file (such as, licenses corresponding to the one or more users, availability of computing resources for the one or more users, one or more secrets (e.g., authentication credentials, encryption keys, tokens, passwords, certificates), and/or other types of information associated with the one or more users that can be used to determine whether the template file can be used to deploy the corresponding resource configuration.

Step 406 includes a test to check whether the template file is valid. If the template file is not validated, then the process continues to step 408, which includes disabling the deployment configuration. Step 410 includes updating a deployment interface (e.g., a user interface associated with user device 202), so that the user device is prevented from using the template file for a deployment. If the template file is validated (e.g., the result of step 406 is yes), then the process continues to step 412, which includes enabling the deployment configuration. The deployment interface is then updated at step 410 so that the user device can trigger a deployment with the template file. The process can then return to step 402 such that template files can be validated as events occur.

It is to be appreciated that the validation process depicted in FIG. 4 is assumed to be an asynchronous process that is performed prior to the template files being used to deploy computing resources.

As an example, in the context of FIG. 2, the validation process in step 404 can include parsing the template file and generating one or more application programming interface (API) requests to obtain information relevant to the resource configuration. For example, one or more API requests can be sent to resource pool 228 if a quantity and/or type of resources for the configuration are currently available.

One or more API requests can also be sent to the address server 220 to determine how many internet protocol (IP) addresses are needed for the configuration (e.g., based on the quantity and/or type of resources). For example, if the configuration corresponds to a particular type and number of computing nodes, then this can be validated by checking a type of network configuration (e.g., a single stack or dual stack configuration), a type of operating system (OS), and/or NICs to determine a type of IP address (e.g., IPv4 or IPv6) and a number of IP addresses that are needed for the configuration in the template file. As a more particular example, the automated deployment system 205 can send an API request to the address server 220 to retrieve available IP addresses. If a particular subnet is specified in the template file, then the automated deployment system 205 can generate an API request to obtain available IP addresses in the range of the subnet. In some embodiments, the automated deployment system 205 can generate one or more API requests to retrieve and/or create secrets from the secrets engine 222. In some embodiments, if a secret identifier (which is not considered sensitive information) is provided in the template file, then the secret can be automatically retrieved from the secrets engine 222. Such an embodiment can help avoid a situation where the secret is provided in plaintext in the template file. If the template file is eventually used for a deployment, then the secrets can be generated and stored in the secrets engine 222 for that deployment. The secret identifiers are later returned to the operator after the deployment is complete. Managing secrets in this way allows template files to be shared as the secrets are not included in plaintext. It is noted that security policies like role-based access control (RBAC) can be used to determine if a given user is allowed to retrieve secrets from the secrets engine 222 and/or create secrets in the secrets engine 222.

The automated deployment system 205 can also validate the necessary quantity and type of licenses available from the license server 224 as needed by the configuration, for example, via one or more API requests. For example, values specified in the template file can be used to determine the type of license keys for the configuration, such as time-based licenses, node-based licenses, and/or utilization-based licenses. This allows the template file to be reused as the license keys are not hardcoded in the template file, and the license keys also do not have to be manually provided by a user.

It is noted that the validation process, in some embodiments, can encompass on-premises license keys, disconnected license keys, and and/or cloud-based licensing models. As an example, for on-premises license keys and disconnected license keys, the validation process can include a connectivity check to a local registration server. For cloud-based deployments, the validation can include a connectivity check to a remote registration server. The license validations can include license availability, operator access permissions, and/or connectivity to a license registration method, as non-limiting examples.

If at least some of the information for deploying the configuration corresponding to the template file is missing and/or invalid, then the validation fails, and the deployment interface can be updated accordingly. The validation can fail for different reasons such as incompatible hardware, unavailability of required resources, and/or insufficient permissions.

In some embodiments, at least a portion of the API requests corresponding to the different elements 220, 222, 224, 226, and/or 228 of the cloud platform 201 can be implemented using one or more REST (representational state transfer) APIs, for example.

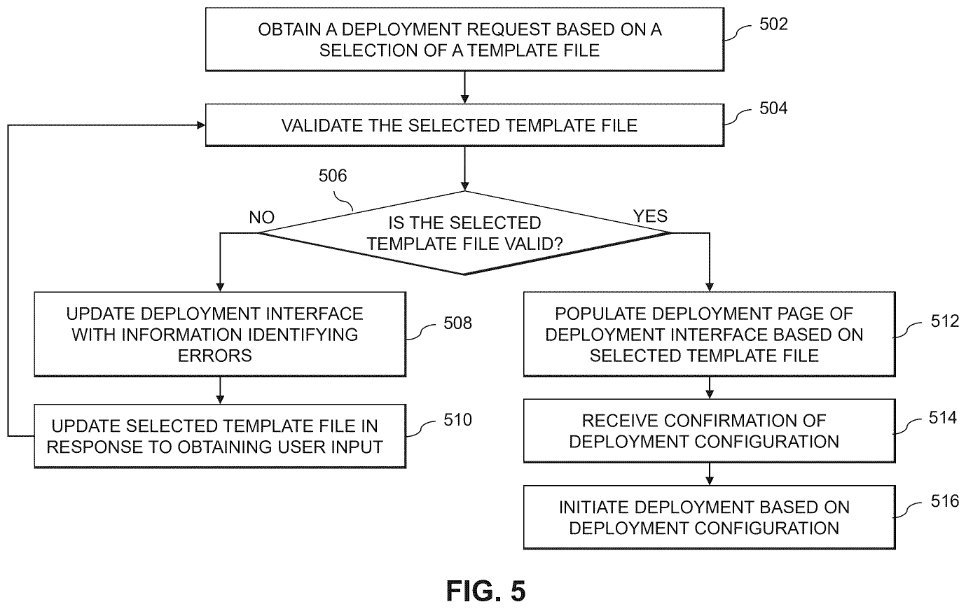

FIG. 5 shows a flow diagram of a deployment process in an illustrative embodiment. In this embodiment, the process includes steps 502 through 516. These steps are assumed to be performed by the automated deployment system 205, for example.

Step 502 includes obtaining a deployment request based on a selection of a template file. For example, the selection can be made by a user (e.g., corresponding to user device 202) by selecting the template file within a deployment interface. Step 504 includes validating the selected template file. It is noted that the validation process described in step 404 of FIG. 4 can be referred to as an asynchronous, pre-validation process as it is performed in response to an occurrence of one or more particular events related to the template file (e.g., changes to the template file) and separate from the deployment of the computing resources, whereas step 504 is performed in response to a deployment request that uses the template file. The validation in step 504 can be performed in a similar manner as described above for step 404, for example.

Step 506 includes a test to determine if the template file is valid. If no, then step 508 is performed, which includes updating the deployment interface with information identifying one or more errors. Step 510 includes updating the selected template file in response to obtaining user input (e.g., via the deployment interface). The process then returns to step 504 to validate the updated template file.

If the template file is validated (i.e., a yes result at step 506), then step 512 is performed, which includes populating a deployment page of the deployment interface based on the selected template file. For example, the deployment page can include a set of default values that are populated based on the template file. In some embodiments, the user can modify (e.g., add, remove, and/or update) the parameters. Step 514 includes receiving a confirmation of a deployment configuration (e.g., via the deployment interface). Step 516 includes initiating a deployment based on the deployment configuration.

In some embodiments, step 516 can include aggregating the information retrieved from the API calls (e.g., corresponding to step 504) that were made to individual components, and then using the aggregated information to automatically create and send an API request to at least one deployment orchestration service. As an example, for a bare metal deployment, the deployment orchestration service can deploy and configure one or more bare metal servers. In such an example, the deployment orchestration service can configure the cluster, using the appropriate APIs (e.g., corresponding to a resource provider that provides the computing resources), specified by the template file. Those skilled in the art will appreciate that different services and/or interfaces can be used for other types of deployments.

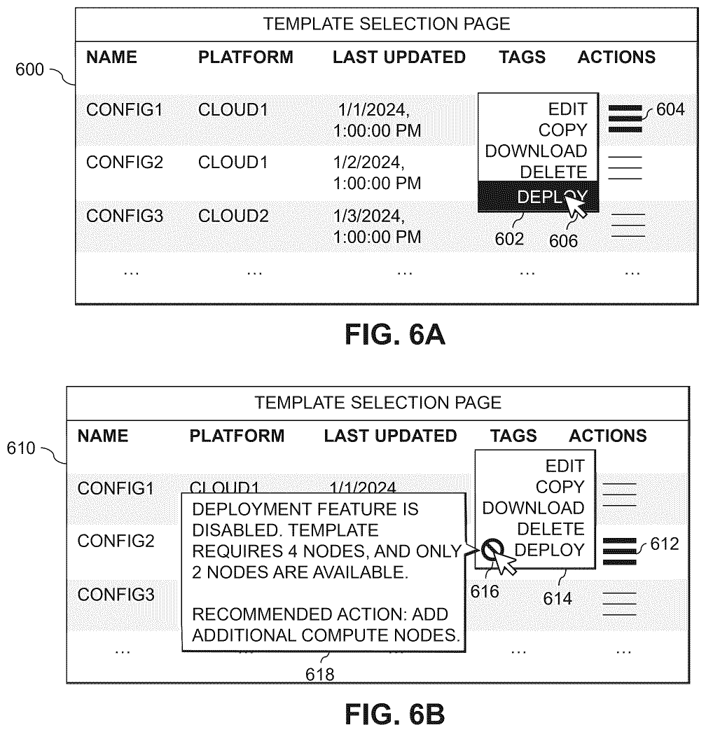

FIGS. 6A and 6B show respective views 600 and 610 of a template selection page of a deployment interface in an illustrative embodiment. More specifically, view 600 shows a list of template files and corresponding information, which, in this example, includes names of the template files, platforms corresponding to the template files, when the template files were last updated, and tags (e.g., specified by a given users). A list of actions 602 related to the template file named CONFIG1 can be presented when a user selects an actions button 604. In this embodiment, the list of actions includes options to edit, copy, download, delete and deploy the template file. It is assumed that the template file has been pre-validated, and thus the deploy feature is enabled in the list of actions 602. The view 600 shows that the user has selected the deploy feature using a pointer 606, as indicated by the dark shading. In some embodiments, the process described in conjunction with FIG. 5 can be performed in response to the deploy action being selected from the list of actions 602 presented when a user selects an actions button 604.

FIG. 6B shows another view 610 of the template selection page. In this example, the user has selected the actions button 612 for the template file named CONFIG. 2, which activates a corresponding list of actions 614. In this example, it is assumed that the template file did not pass the pre-validation process, and therefore the deploy feature is disabled as indicated by the symbol 616. The deployment interface, in some embodiments, can provide additional information describing why the deploy feature is disabled and one or more recommend actions for addressing the identified issues. For example, in view 610, the user can be presented with text 618 in response to interacting with the symbol 616.

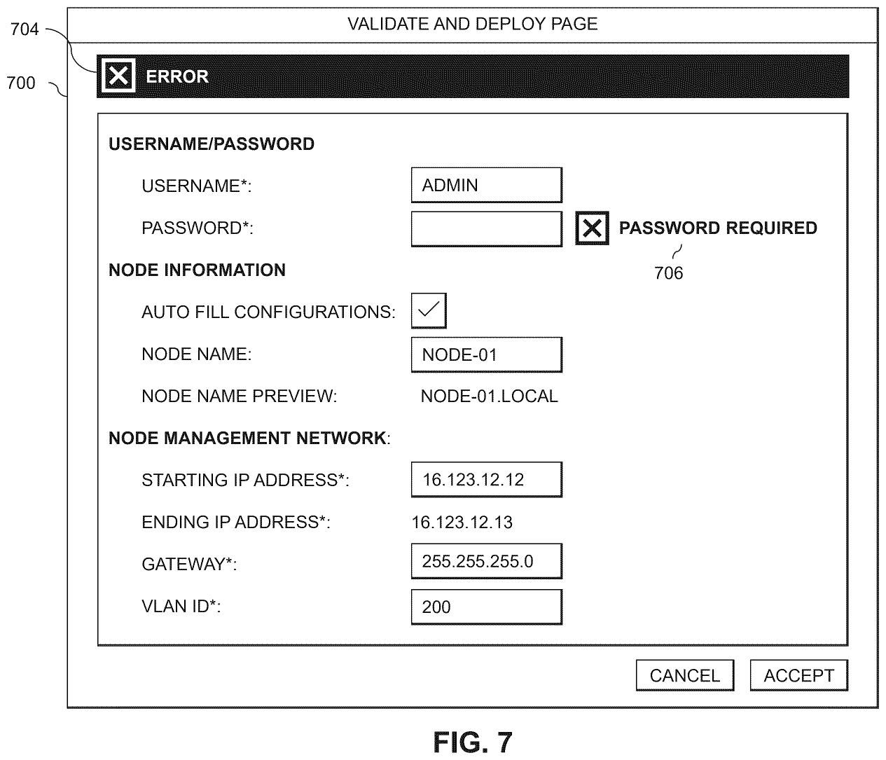

FIG. 7 shows a view 700 of a deployment interface in an illustrative embodiment. The view 700 corresponds to a validate and deploy page showing one or more errors in response to a user selecting a deploy feature for a given template file (e.g., the deploy feature in the list of actions 602). For example, the view 700 can correspond to the deployment interface as updated by step 508 of FIG. 5. In this example, it is assumed that certain fields are required (as indicated by the * symbol) for the deployment configuration, and that the information for the password field is missing. The view 700 identifies the error using a banner 704 and includes text 706 describing the error. According to some embodiments, an error can result from one or more values not being scanned during the pre-validation process and/or errors resulting from changes that occurred from when the template was pre-validated (e.g., changes to licenses, resources, etc.). The view 700 allows the user to enter the password to address the errors and/or update other information related to the configuration.

According to some embodiments, the deployment interface can also be configured to present the user with a view similar to view 700 in response to detecting an error during the pre-validation process (e.g., step 404).

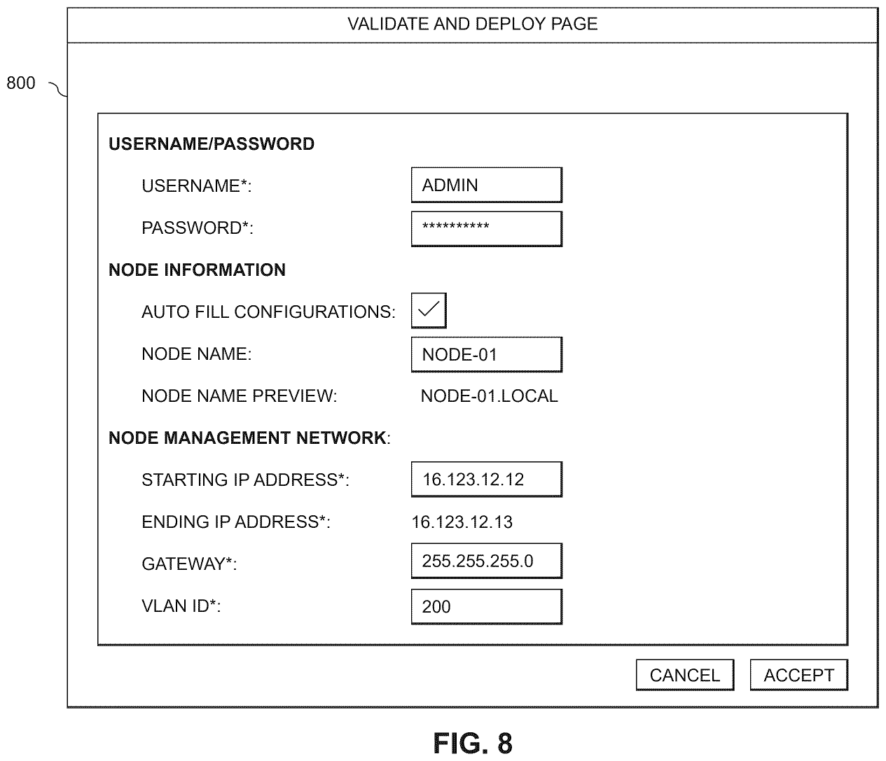

FIG. 8 shows another view 800 of a deployment interface in an illustrative embodiment. The view 800 is similar to the view 700, except no errors have been identified with the selected template.

It is to be appreciated that views 600, 610, 700, and 800 are merely examples and are not intended to be limiting. For example, the views 600, 610, 700, and/or 800 may include different and/or additional GUI elements such as, different fields, symbols, and/or information about the template files and/or resource configurations, for example.

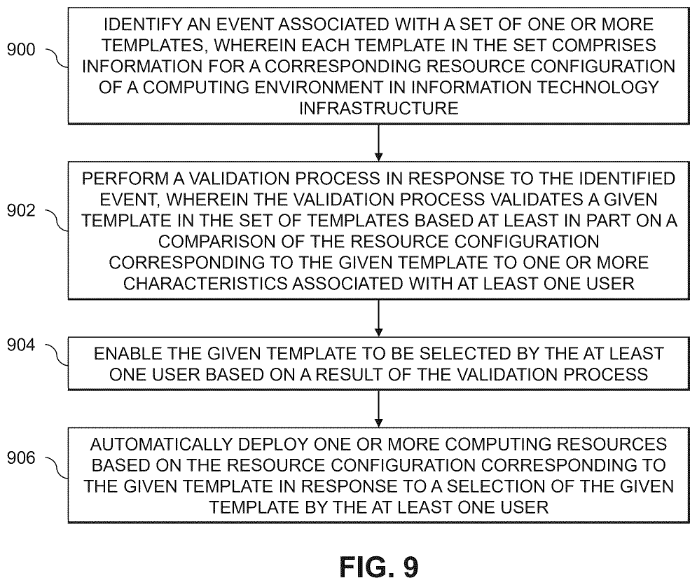

FIG. 9 is a flow diagram of a process for automated deployment of resources using validated templates in an illustrative embodiment. It is to be understood that this particular process is only an example, and additional or alternative processes can be carried out in other embodiments.

In this embodiment, the process includes steps 900 through 906. These steps are assumed to be performed by the automated deployment system 105 utilizing its elements 112, 114, and 116.

Step 900 includes identifying an event associated with a set of one or more templates, wherein each template in the set comprises information for a corresponding resource configuration of a computing environment in information technology infrastructure. Step 902 includes performing a validation process in response to the identified event, wherein the validation process validates a given template in the set of templates based at least in part on a comparison of the resource configuration corresponding to the given template to one or more characteristics associated with at least one user. Step 904 includes enabling the given template to be selected by the at least one user based on a result of the validation process. Step 906 includes automatically deploying one or more computing resources based on the resource configuration corresponding to the given template in response to a selection of the given template by the at least one user.

The given template may include information corresponding to at least one of one or more types of computing resources to be deployed and one or more characteristics associated with a given one of the one or more types of computing resources. The one or more characteristics associated with the at least one user may correspond to at least one of an availability of a set of computing resources comprising the one or more computing resources, one or more licenses associated with the set of computing resources, network information associated with the set of computing resources, and one or more credentials associated with the set of computing resources. The event may include a template being added to the set of templates and/or at least one change to at least one template in the set of templates. The enabling may include causing, in response to the given template being validated, an update to a user interface that enables the selection of the given template by the at least one user. The update to the user interface may prevent the at least one user from selecting one or more invalid templates in a set of templates to deploy. The update to the user interface may cause information to be presented indicating one or more reasons for an invalidation of at least one of the one or more invalid templates in the set of templates. Automatically deploying the one or more computing resources may include populating one or more fields of the given template based at least in part on the one or more characteristics. The process may further include the following steps determining information that is missing from at least one field of the given template; and generating a request to obtain the missing information from the at least one user. The one or more computing resources may correspond to one or more containers, one or more virtual machines, and/or one or more bare metal servers.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to efficiently deploy resources in an automated manner. These and other embodiments can effectively reduce the number of deployment failures and improve user experience relative to conventional approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionalities within the system 100. For example, containers can be used to implement respective processing devices providing compute and/or storage services of a cloud-based system. Again, containers may be used in combination with other virtualization infrastructure such as virtual machines implemented using a hypervisor.

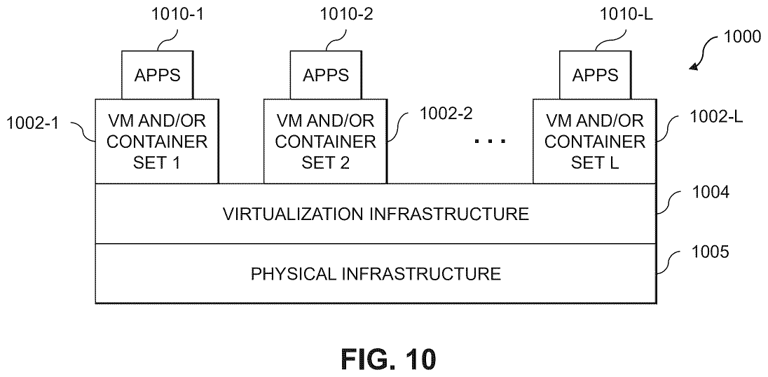

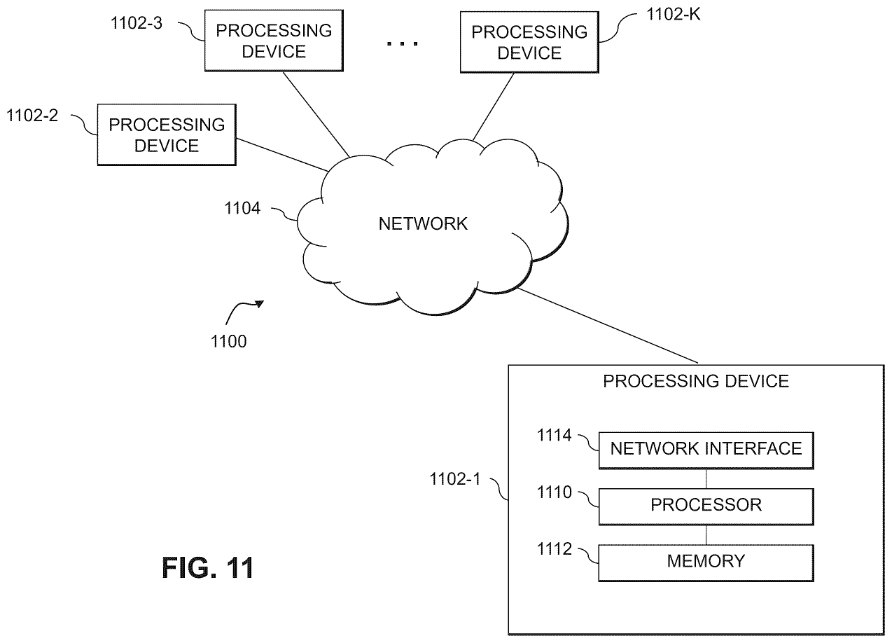

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple VMs and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, a microcontroller, an ASIC, an FPGA or other type of processing circuitry, as well as portions or combinations of such circuitry elements.

The memory 1112 comprises RAM, ROM or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying an event associated with a set of one or more templates, wherein each template in the set comprises information for a corresponding resource configuration of a computing environment in information technology infrastructure;
performing a validation process in response to the identified event, wherein the validation process validates a given template in the set of templates based at least in part on a comparison of the resource configuration corresponding to the given template to one or more characteristics associated with at least one user;
enabling the given template to be selected by the at least one user based on a result of the validation process; and
automatically deploying one or more computing resources based on the resource configuration corresponding to the given template in response to a selection of the given template by the at least one user;
wherein the method is performed by at least one processing device comprising a processor coupled to a memory.

2. The computer-implemented method of claim 1, wherein the given template comprises information corresponding to at least one of:
one or more types of computing resources to be deployed; and
one or more characteristics associated with a given one of the one or more types of computing resources.

3. The computer-implemented method of claim 1, wherein the one or more characteristics associated with the at least one user corresponds to at least one of:
an availability of a set of computing resources comprising the one or more computing resources;
one or more licenses associated with the set of computing resources;
network information associated with the set of computing resources; and
one or more credentials associated with the set of computing resources.

4. The computer-implemented method of claim 1, wherein the event comprises at least one of:
a template being added to the set of templates; and
at least one change to at least one template in the set of templates.

5. The computer-implemented method of claim 1, wherein the enabling comprises:
causing, in response to the given template being validated, an update to a user interface that enables the selection of the given template by the at least one user.

6. The computer-implemented method of claim 5, wherein the update to the user interface prevents the at least one user from selecting one or more invalid templates in a set of templates to deploy.

7. The computer-implemented method of claim 6, wherein the update to the user interface causes information to be presented indicating one or more reasons for an invalidation of at least one of the one or more invalid templates in the set of templates.

8. The computer-implemented method of claim 1, wherein the automatically deploying the one or more computing resources comprises:
populating one or more fields of the given template based at least in part on the one or more characteristics.

9. The computer-implemented method of claim 1, comprising:
determining information that is missing from at least one field of the given template; and
generating a request to obtain the missing information from the at least one user.

10. The computer-implemented method of claim 1, wherein the one or more computing resources correspond to at least one of:
one or more containers;
one or more virtual machines; and
one or more bare metal servers.

11. A non-transitory processor-readable storage medium having stored therein program code of one or more software programs, wherein the program code when executed by at least one processing device causes the at least one processing device:
to identify an event associated with a set of one or more templates, wherein each template in the set comprises information for a corresponding resource configuration of a computing environment in information technology infrastructure;
to perform a validation process in response to the identified event, wherein the validation process validates a given template in the set of templates based at least in part on a comparison of the resource configuration corresponding to the given template to one or more characteristics associated with at least one user;
to enable the given template to be selected by the at least one user based on a result of the validation process; and
to automatically deploy one or more computing resources based on the resource configuration corresponding to the given template in response to a selection of the given template by the at least one user.

12. The non-transitory processor-readable storage medium of claim 11, wherein the given template comprises information corresponding to at least one of:
one or more types of computing resources to be deployed; and
one or more characteristics associated with a given one of the one or more types of computing resources.

13. The non-transitory processor-readable storage medium of claim 11, wherein the one or more characteristics associated with the at least one user corresponds to at least one of:
an availability of a set of computing resources comprising the one or more computing resources;
one or more licenses associated with the set of computing resources;
network information associated with the set of computing resources; and
one or more credentials associated with the set of computing resources.

14. The non-transitory processor-readable storage medium of claim 11, wherein the event comprises at least one of:
a template being added to the set of templates; and
at least one change to at least one template in the set of templates.

15. The non-transitory processor-readable storage medium of claim 11, wherein the enabling comprises:
causing, in response to the given template being validated, an update to a user interface that enables the selection of the given template by the at least one user.

16. An apparatus comprising:
at least one processing device comprising a processor coupled to a memory;
the at least one processing device being configured:
to identify an event associated with a set of one or more templates, wherein each template in the set comprises information for a corresponding resource configuration of a computing environment in information technology infrastructure;
to perform a validation process in response to the identified event, wherein the validation process validates a given template in the set of templates based at least in part on a comparison of the resource configuration corresponding to the given template to one or more characteristics associated with at least one user;
to enable the given template to be selected by the at least one user based on a result of the validation process; and
to automatically deploy one or more computing resources based on the resource configuration corresponding to the given template in response to a selection of the given template by the at least one user.

17. The apparatus of claim 16, wherein the given template comprises information corresponding to at least one of:
one or more types of computing resources to be deployed; and
one or more characteristics associated with a given one of the one or more types of computing resources.

18. The apparatus of claim 16, wherein the one or more characteristics associated with the at least one user corresponds to at least one of:
an availability of a set of computing resources comprising the one or more computing resources;
one or more licenses associated with the set of computing resources;
network information associated with the set of computing resources; and
one or more credentials associated with the set of computing resources.

19. The apparatus of claim 16, wherein the event comprises at least one of:
a template being added to the set of templates; and
at least one change to at least one template in the set of templates.

20. The apparatus of claim 16, wherein the enabling comprises:
causing, in response to the given template being validated, an update to a user interface that enables the selection of the given template by the at least one user.
